(19) United States
(12) Patent Application Publication
(10) Pub. No.: US 2018/0356104 A1
(43) Pub. Date: Dec. 13, 2018

(54) INTELLIGENT WATER PURIFYING SYSTEM

(71) Applicant: XIAMEN FILTERTECH INDUSTRIAL CORPORATION, Xiamen (CN)

(72) Inventors: HONG-KUN XU, Xiamen (CN); FENG-SHUN ZHAN, Xiamen (CN); JIAN-YONG YAN, Xiamen (CN)

(21) Appl. No.: 15/992,166

(22) Filed: May 29, 2018

(30) Foreign Application Priority Data
Jun. 8, 2017 (CN) 201710427764.2

(51) Int. Cl. F24D 17/00; C02F 1/28; C02F 1/44

(52) U.S. Cl. CPC F24D 17/0089; C02F 2103/04; C02F 1/44; C02F 1/283

(57) ABSTRACT

An intelligent water purifying system includes a water purifying module, a heating module, a raw water inlet port, and a pure water outlet port. An inlet end of the water purifying module is connected and in communication with a raw water inlet port, a water outlet end of the water purifying module is connected and in communication with an inlet port of the heating module, and an outlet port of the heating module is connected and in communication with a hot water output pipe. The heating module includes: a heating tank for storing water, and a heating module controller used to control heating of pure water in the heating tank to a preset temperature. The intelligent water purifying system is able to provide water purifying and heating functions at the same time.

### BACKGROUND OF THE INVENTION

### Field of the Invention

The present invention relates to a water purifying system, and in particular to an intelligent water purifying system.

### The Prior Arts

Along with the raise of living standard, people are paying more attention to the hygiene of using water. As such, water purifying equipment has become a necessity in every household. The major function of a water purifying equipment is to filter out impurity and to purify water. However, in the past, water purifying equipment is only able to provide water purifying capability. Due to the demand and requirement of the consumer for hot water, the water purifying equipment presently available on the market is capable of providing hot water, and has the capability of providing hot water instantly. Namely, when it is required to use hot water, the purified water is heated by a heater, to produce instant hot water. Yet, at present, the instant heating type water purifying equipment has at least the following deficiencies: (1) Since the water is heated instantly, it has to consume more power, while the hot water flow produced is rather small (about 0.3-0.4 L/min), so that a user has to wait for a long time to get sufficient hot water. (2) Due to the small hot water flow produced, it tends to lose heat, so the distance between the water heating pipe and the water output port must be short, thus the heating type water purifying equipment has to be put on the faucet table, to occupy unnecessarily additional space.

Therefore, presently, the design and performance of the water purifier is not quite satisfactory, and it leaves much room for improvement.

### SUMMARY OF THE INVENTION

In view of the problems and drawbacks of the prior art, the present invention provides an intelligent water purifying system, that is capable of achieving water purifying and water heating functions at the same time. Since hot water can be prepared and stored in advance, the distance between the water heating pipe and the water output port can be made longer without the need to worrying about heat loss. As such, the heating type water purifying equipment can be put under the faucet table, to save the space occupied above the faucet table.

The objective of the present invention is to provide an intelligent water purifying system, that includes: a water purifying module, a heating module, a raw water inlet port, and a pure water outlet port. Wherein, an inlet end of the water purifying module is connected and in communication with a raw water inlet port, while a water outlet end of the water purifying module is connected and in communication with an inlet port of the heating module, and an outlet port of the heating module is connected and in communication with a hot water output pipe.

The heating module includes: a heating tank for storing water, and a heating module controller used to control heating of pure water in the heating tank to a preset temperature.

In an aspect of the present invention, the intelligent water purifying system further includes: a control valve, used to control the water outlet end of the water purifying module to be connected to the pure water outlet port, or to the inlet port of the heating module.

In another aspect of the present invention, the control valve includes a first valve and a second valve. The first valve is disposed in a pipeline between the water outlet end of the water purifying module and the pure water outlet port, the second valve is disposed in the pipeline between the water outlet end of the water purifying module and the inlet port of the heating module.

In a yet another aspect of the present invention, the intelligent water purifying system further includes a waste water outlet port; and the heating module further includes an overflow cavity. The overflow cavity is disposed on a top of the heating tank, and is connected and in communication with the heating tank. An overflow port is disposed on the overflow cavity, the overflow port is connected and in communication with the waste water outlet port through an overflow water pipeline.

In a further aspect of the present invention, the intelligent water purifying system further includes: an air communication device and a check valve, both disposed on the overflow water pipeline, the air communication device is disposed close to the overflow port, and the check valve is disposed between the air communication device and the waste water outlet port, the air communication device is used to balance pressure in the overflow cavity, and the check valve is used to prevent waste water produced by the intelligent water purifying system from flowing back reversely to the overflow cavity through the overflow water pipeline.

In an aspect of the present invention, an air penetrating diaphragm is disposed on the air communication device, to allow gas phase material to pass through.

In another aspect of the present invention, the water purifying module includes the following in sequence: a first stage PP filter cartridge, a second stage carbon rod filter cartridge, a third stage RO film filter cartridge, and a fourth stage post carbon rod filter cartridge.

In a yet another aspect of the present invention, a flush and clean pipeline is diverted and extended out from behind the fourth stage post carbon rod filter cartridge of the water purifying module, such that the flush and clean pipeline is connected and in communication with the waste water outlet port.

In a further aspect of the present invention, waste water filtered through the third stage RO film filter cartridge is in communication with waste water outlet port through a waste water pipeline.

In the present invention the intelligent water purifying system has the following advantages:

In the present invention, the intelligent water purifying system is provided with a water purifying module and a heating module. The water outlet end of the water purifying module is connected and in communication with a pure water outlet port of the water purifying module, and an inlet port of the heating module. An outlet port of the heating module is connected and in communication with a hot water output port. The heating module includes: a heating tank for storing water, and a heating module controller used to control heating of pure water in the heating tank to a preset temperature. Therefore, the intelligent water purifying system is able to purify and heat water at the same time, while heated water is stored in advance, for a user to use at any time as required.

In the present invention, heated water is stored in advance, for a user to use at any time, thus the hot water output amount can be made relatively larger, so that the heat loss in the water output process is reduced. As such, the intelligent water purifying system can be put under the faucet table, to save the space occupied above the faucet table.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detail descriptions.

### BRIEF DESCRIPTION OF THE DRAWINGS

The related drawings in connection with the detailed descriptions of the present invention to be made later are described briefly as follows, in which:

FIG. 1 is a side view of an intelligent water purifying system according to the present invention;

FIG. 2 is a perspective view of an intelligent water purifying system according to the present invention; and

FIG. 3 is a schematic diagram of a water route for an intelligent water purifying system according to the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

### Embodiment 1

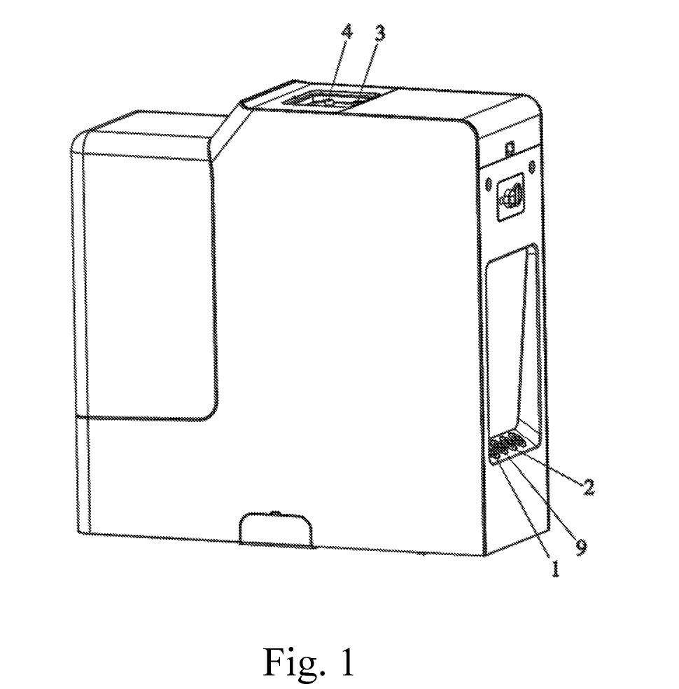

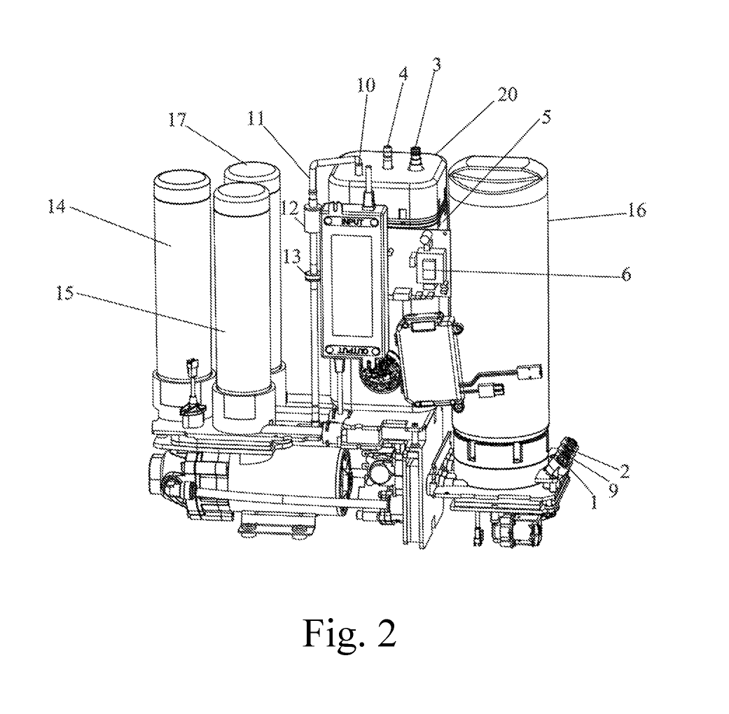

Refer to FIGS. 1 to 3 for a side view of an intelligent water purifying system according to the present invention; a perspective view of an intelligent water purifying system according to the present invention; and a schematic diagram of a water route for an intelligent water purifying system according to the present invention. As shown in FIGS. 1 to 3, in the present embodiment, an intelligent water purifying system is provided, to realize the water purifying and heating functions at the same time. Since the water heated in advance can be stored, so the intelligent water purifying system can be put under the faucet table for water to come out of a faucet, to save the space above the faucet table.

The present invention provides an intelligent water purifying system, that includes: a water purifying module, a heating module, a raw water inlet port 1, and a pure water outlet port 2. Wherein, an inlet end of the water purifying module is connected and in communication with a raw water inlet port 1, while a water outlet end of the water purifying module is connected and in communication with an inlet port 3 of the heating module, and an outlet port 4 of the heating module is connected and in communication with a hot water output pipe. Therefore, raw water flows into the raw water inlet port 1 of the present system through a raw water pipeline, then it flows into the water purifying module through its inlet end, and then the raw water is processed in the water purifying module. The pure water obtained through this processing may flow directly out of the pure water outlet port 2 for a user to use, or the pure water may flow into the heating module, to be heated therein.

The heating module includes: a heating tank 5 for storing water, and a heating module controller 6 used to control heating of pure water in the heating tank 5 to a preset temperature. The heating tank 5 is used to store the pure water heated in advance, when it is required to use hot water, hot water can be exited from the outlet port 4 of the heating tank 5, and then it flows through the hot water outlet pipe for a user to use. Since in using hot water, the hot water stored in the heating tank 5 can be used directly, and there is no need of heating water instantly. As such, the hot water flow can be larger (to prevent the hot water flow from being overly large to splash and hurt people, the hot water flow is limited to 1-2 L/min), while the heat loss on the hot water outlet pipe can be reduced significantly, and the length of the hot water outlet pipe can be lengthened. Therefore, the intelligent water purifying system can be placed under the faucet table, to save the space above the faucet table.

In an embodiment of the present invention, the intelligent water purifying system further includes: a control valve, used to control the water outlet end of the water purifying module to be connected to the pure water outlet port 2, or to the inlet port 3 of the heating module.

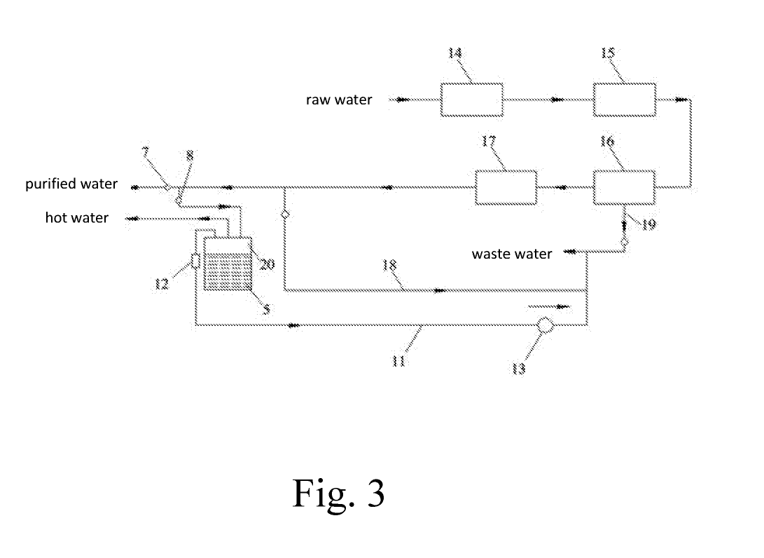

In an embodiment of the present invention, as shown in FIG. 3, the control valve includes: a first valve 7 and a second valve 8. The first valve 7 is disposed in a pipe line between the water outlet end of the water purifying module and the pure water outlet port 2, while the second valve 8 is disposed in the pipe line between the water outlet end of the water purifying module and the inlet port 3 of the heating module.

In order to discharge waste water from the present system, the intelligent water purifying system further includes: a waste water outlet port 9; and the heating module further includes an overflow cavity 20. The overflow cavity 20 is disposed on a top of the heating tank 5, and is connected and in communication with the heating tank 5. An overflow port 10 is disposed on the overflow cavity 20, and the overflow port 10 is connected and in communication with the waste water outlet port 9 through an overflow water pipeline 11.

In an embodiment of the present invention, the intelligent water purifying system further includes an air communication device 12 and a check valve 13, both disposed on the overflow water pipeline 11. The air communication device 12 is disposed close to the overflow port 10, and the check valve 13 is disposed between the air communication device 12 and the waste water outlet port 9. The air communication device 12 is used to balance pressure in overflow cavity 20, and the check valve 13 is used to prevent waste water produced by the intelligent water purifying system from flowing back reversely to the overflow cavity 20 through the overflow water pipeline 11.

When water in the heating tank 5 is heated, a small amount of inflated hot water tends to flow into the overflow cavity 20 of the heating module, while the hot air produced is discharged through the air communication device 12, to effectively prevent pressure stifling in the heating tank 5.

In general, when the hot water is used, the hot water level in the heating tank 5 is reduced, to produce a certain negative pressure, such that the hot water in the overflow cavity 20 is sucked back to the heating tank 5. At this time, air is sucked into the overflow cavity 20 through the air communication device 12, to achieve balance of pressure. When the inflated hot water is increased thus the overflow cavity 20 is full of hot water, a small amount of hot water tends to flow into the overflow water pipeline 11 through the overflow port 10, and then it exits from the waste water outlet port 9, to avoid stifling of pressure in the overflow cavity 20. A check valve 13 is disposed behind the air communication device 12, to effectively prevent waste water produced by the intelligent water purifying system from flowing back reversely to the overflow cavity 20 through the overflow water pipeline 11.

In an embodiment of the present invention, an air penetrating diaphragm is disposed on the air communication device 12, to allow gas phase material to pass through. Namely, through the air penetrating diaphragm air can be flowed in, while hot air can be exited, yet it will not cause the water to flow out from the overflow water pipeline 11.

In an embodiment of the present invention, the water purifying module includes the following in sequence: a first stage PP filter cartridge 14, a second stage carbon rod filter cartridge 15, a third stage RO film filter cartridge 16, and a fourth stage post carbon rod filter cartridge 17. In this approach, raw water flows in the water purifying module through its inlet end, then it flows out of the water outlet end of the water purifying module after four-stage purifying, in achieving effective purification of raw water.

In an embodiment of the present invention, a flush and clean pipeline 18 is diverted and extended out from behind the fourth stage post carbon rod filter cartridge 17 of the water purifying module, such that the flush and clean pipeline 18 is connected and in communication with the waste water outlet port 9, to exit the waste water produced by cleaning the water purifying module.

In an embodiment of the present invention, waste water filtered through the third stage RO film filter cartridge 16 is in communication with waste water outlet port 9 through a waste water pipeline 19.

In the present invention, the intelligent water purifying system has the following advantages:

In the present invention, the intelligent water purifying system is provided with a water purifying module and a heating module. The water outlet end of the water purifying module is connected and in communication with a pure water outlet port of the water purifying module, and an inlet port 3 of the heating module. An outlet port 4 of the heating module is connected and in communication with a hot water output port. The heating module includes: a heating tank 5 for storing water, and a heating module controller 6 used to control heating of pure water in the heating tank 5 to a preset temperature. Therefore, the intelligent water purifying system is able to purify and heat water at the same time, while heated water is stored in advance, for a user to use at any time as required.

In the present invention, heated water is stored in advance, for a user to use at any time, thus the hot water output amount can be made relatively larger, so that the heat loss in the water output process is reduced. As such, the intelligent water purifying system can be put under the faucet table, to save the space occupied above the faucet table.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. An intelligent water purifying system, comprising:
a water purifying module, a heating module, a raw water inlet port, and a pure water outlet port;
an inlet end of the water purifying module is connected and in communication with the raw water inlet port, and a water outlet end of the water purifying module is connected and in communication with an inlet port of the heating module, and an outlet port of the heating module is connected and in communication with a hot water output pipe;
the heating module includes: a heating tank for storing water, and a heating module controller used to control heating of pure water in the heating tank to a preset temperature.

2. The intelligent water purifying system as claimed in claim 1, further comprising:
a control valve, used to control the water outlet end of the water purifying module to be connected to the pure water outlet port, or to the inlet port of the heating module.

3. The intelligent water purifying system as claimed in claim 2, wherein the control valve includes: a first valve and a second valve, the first valve is disposed in a pipe line between the water outlet end of the water purifying module and the pure water outlet port, the second valve is disposed in the pipe line between the water outlet end of the water purifying module and the inlet port of the heating module.

4. The intelligent water purifying system as claimed in claim 3, further comprising:
a waste water outlet port; and the heating module further includes an overflow cavity, the overflow cavity is disposed on a top of the heating tank, and is connected and in communication with the heating tank, an overflow port is disposed on the overflow cavity, the overflow port is connected and in communication with the waste water outlet port through an overflow water pipeline.

5. The intelligent water purifying system as claimed in claim 4, further comprising:
an air communication device and a check valve, both disposed on the overflow water pipeline, the air communication device is disposed close to the overflow port, and the check valve is disposed between the air communication device and the waste water outlet port, the air communication device is used to balance pressure in the overflow cavity, and the check valve is used to prevent waste water produced by the intelligent water purifying system from flowing back reversely to the overflow cavity through the overflow water pipeline.

6. The intelligent water purifying system as claimed in claim 5, wherein an air penetrating diaphragm is disposed on the air communication device, to allow gas phase material to pass through.

7. The intelligent water purifying system as claimed in claim 1, wherein the water purifying module includes the following in sequence: a first stage PP filter cartridge, a second stage carbon rod filter cartridge, a third stage RO film filter cartridge, and a fourth stage post carbon rod filter cartridge.

8. The intelligent water purifying system as claimed in claim 7, wherein a flush and clean pipeline is diverted and extended out from behind the fourth stage post carbon rod filter cartridge of the water purifying module, such that the flush and clean pipeline is connected and in communication with the waste water outlet port.

9. The intelligent water purifying system as claimed in claim 7, wherein waste water filtered through the third stage RO film filter cartridge is in communication with waste water outlet port through a waste water pipeline.
